(19) United States
(12) Patent Application Publication
(10) Pub. No.: US 2001/0045673 A1
(43) Pub. Date: Nov. 29, 2001

(54) Compact apparatus for oxygen dissolution & distribution

(76) Inventors: Mervyn R. Ogston, Queensland (AU); Ross Ellen, Alexandria (AU)

Correspondence Address: THE BOC GROUP INC, 100 MOUNTAIN AVENUE, MURRAY HILL, NEW PROVIDENCE, NJ, 07974-2064, US

(21) Appl. No.: 09/788,488

(22) Filed: Feb. 21, 2001

(30) Foreign Application Priority Data
Feb. 21, 2000 (AU) PQ 5756

(51) Int. Cl. B01F 3/04

(52) U.S. Cl. 261/76; 261/DIG. 27; 261/75

(57) ABSTRACT

A method and apparatus for dissolving oxygen in water is provided. The method comprises introducing a supply of oxygen containing gas into a pressurized stream of water to produce a two phase flow and reducing the gas bubble size in the flow allowing time for mass transfer between the bubbles and the water.

### FIELD OF THE INVENTION

The invention relates to a method and apparatus for dissolving oxygen in water. It has been developed primarily for use in doing so at high concentrations with high oxygen transfer efficiency and also providing for distribution into bulk water.

### BACKGROUND OF THE INVENTION

A number of existing technologies have sought to dissolve high concentrations of oxygen in a stream of water. Some examples of such systems include:

Down flow bubble contactors (DFBC, also referred to as bicones or Spreece cones), counter-current diffusion column, U-tube dissolvers, pressurized spray towers, pressurised packed columns, and venturi injection devices.

DFBC's, counter current diffusion columns and U-tube dissolvers each rely on the buoyancy of relatively large oxygen gas bubbles in a low velocity counter-current water stream. Due to these low water velocities, the equipment is large and expensive. The oxygen transfer is limited by the mass transfer rate which is low due to the relatively low surface area of the bubbles. Also, the efficiencies are generally low due to the passage of entrained bubbles (even with attempts to collect and recycle undissolved gas) The DFBC has the highest oxygen transfer rate of the three designs due to an expanding cone which reduces the bubble size prior to entrainment and increases the contact time. However, the economic operating pressure of the equipment is low and the resulting maximum oxygen concentration obtainable is low. Moreover, each of these systems is subject to bio-fouling due to the low water velocities.

Pressurised spray towers incorporate a pressure vessel with water sprayed into the oxygen atmosphere. Efficiency is relatively low, spray nozzles are subject to blocking and the vessel is subject to bio-fouling as well as being large and expensive.

Pressurised packed columns additionally incorporate packing to increase the phase contact area within the pressurised column. Efficiency is relatively low, at best only slightly higher than that of the pressurised spray columns and packing is subject to bio-fouling and blockages requiring regular cleaning. Additionally, the cost of the packing makes these more expensive than the unpacked columns.

As the name would suggest, venturi devices use a venturi to inject oxygen into a pressurised water flow on the discharge of a pump. The dissolution efficiency is low due to relatively large bubble size, minimal turbulence for contact and minimal contact time for dissolution. The operating pressure is generally relatively low, thus limiting the maximum possible concentration of dissolved oxygen.

The current technology does not achieve oxygen transfer efficiencies in conjunction with high dissolved oxygen distribution to multiple and a variable number of bodies of water.

It is an object of the present invention to overcome or ameliorate at least one of the disadvantages of the prior art, or to provide a useful alternative.

### SUMMARY OF THE INVENTION

According to a first aspect of the invention, there is provided a method for dissolving oxygen in water, the method including the following steps:

a) generating a pressurised stream of water;

b) introducing a supply of oxygen containing gas to said pressurised stream of water to produce a two phase flow;

c) passing the two phase flow through a turbulent dissolver zone whereby the gas bubble size is reduced and the two phases are violently mixed;

d) passing the two phase flow through a contact dissolver zone allowing time for mass transfer between the smaller bubbles and the water;

e) where required, repeating steps c) and d) until a desired level of dissolved gas is achieved at said elevated pressure.

Preferably, the velocity of the pressurised stream is increased prior to the supply of the oxygen stream.

Preferably, the pressurised stream of water is generated within a conduit by a pump, however, in other forms gravity drop systems or other techniques may be used.

Preferably, the flow velocity of the pressurised stream is increased by narrowing the conduit from a first cross-section to a second smaller cross-section.

Preferably, the or each contact dissolver zone comprises a length of piping.

Preferably, the length of piping is of substantially constant cross-section.

In the preferred form of the invention, the second, smaller cross-section to the conduit is substantially equal to that of the piping used to define the dissolver zones.

According to a second aspect of the invention there is provided apparatus for dissolving oxygen in water, the apparatus including:

means for generating a pressurised stream of water;

gas mixing means for mixing said pressurised stream with a supply of gas to form a two phase flow; and

a dissolver including:

at least one turbulent dissolver zone arranged to promote violent mixing of said two phase flow; and

at least one contact dissolver zone arranged to promote enhanced mass transfer in said two phase flow.

Preferably, means are provided to increase the flow velocity of the pressurised stream upstream of the gas mixing means.

In some preferred forms the apparatus also includes a phase separator to remove at least some of any gas bubbles remaining in the oxygenated stream. In a particularly preferred form, the removed gas bubbles are recycled to the gas mixing means.

According to another aspect of the invention, there is provided an apparatus for distributing an oxygenated stream of water into a bulk volume of water, the apparatus including means for increasing the velocity of said stream and injecting the stream into the bulk volume in a jet such that bulk water adjacent said oxygenated stream is entrained with the jet thereby promote mixing therebetween.

A preferred embodiment of the invention will now be described, by way of example only, with reference to the accompanying drawings in which:

### BRIEF DESCRIPTION OF THE DRAWINGS

FIG. 1 shows a flow diagram of a first embodiment apparatus for dissolving oxygen in water;

FIG. 2 shows a detail view of a turbulent zone of the apparatus shown in FIG. 1;

FIG. 3 shows a flow diagram of a second embodiment apparatus according to the invention;

FIG. 4 shows a partial detail view of the apparatus of FIG. 2;

FIG. 5 shows a first embodiment apparatus for distributing an oxygenated stream of water into a bulk volume of water according to the invention; and

FIG. 6 shows a detail view of part of FIG. 1.

### DETAILED DESCRIPTION OF THE INVENTION

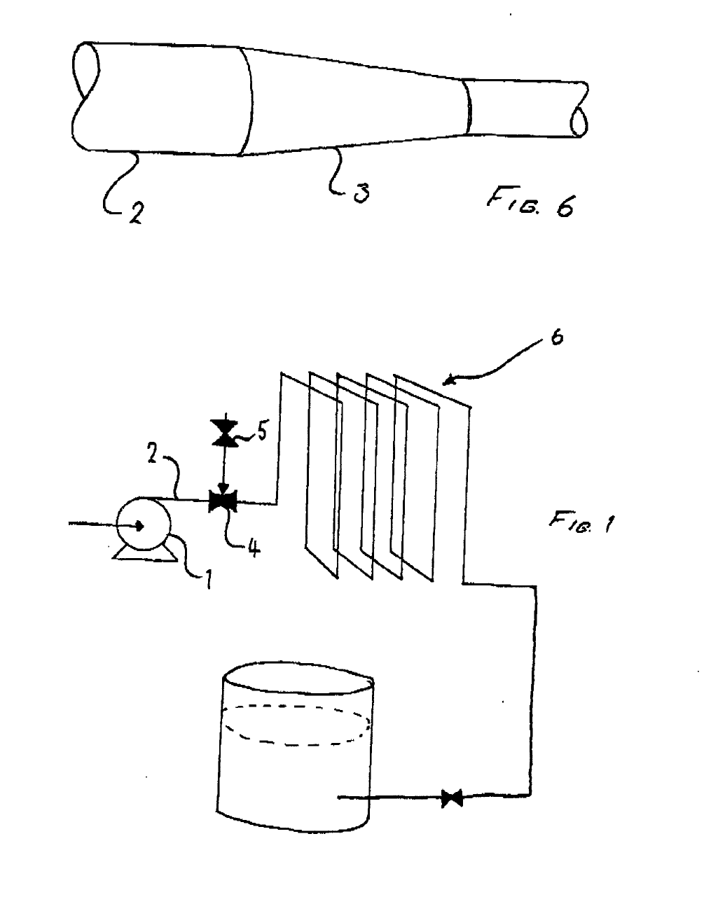

In a first embodiment of the invention, as illustrated in FIG. 1 the aim is to maintain a desired concentration of dissolved oxygen in a single body of water, for example an aquaculture tank where fish (biomass) are grown.

In such applications, the respiratory or oxygen demand by the biomass, and subsequently the demand placed on the oxygenation system, is dependant on a number of factors including:

biomass density and age, water temperature, feeding frequency and tank water flow rate.

To accommodate these variations it is necessary to provide a stream of water having a high concentration of oxygen that can be added to the tank in response to any drop in the dissolved oxygen concentration. Additionally, this stream must be capable of distribution through the body of water in a manner that will not damage the biomass.

To this end, means for generating a pressurised stream of water is provided in the form of a pump 1 arranged to generate a stream of pressurised water in a conduit 2. Means to increase the flow velocity of the pressurised stream is provided in the form of a tapered section 3 of conduit as shown in FIG. 6. A stream of oxygen containing gas as is mixed with the pressurised stream in gas mixing means. Where there is insufficient differential pressure between the oxygen supply pressure and the required water pump discharge pressure the gas mixing means is provided in the form of an in-line venturi 4 is used.

A flow control valve 5 downstream of a flow indicator is used to control the flow of the introduced gaseous oxygen.

The flow of oxygen can be adjusted by the valve 5 to any point in a range between zero flow and a maximum oxygen flow in excess of that required to achieve oxygen saturation at the elevated pressure at the end of the dissolver piping. Oxygen flows in excess of the saturation quantity produce the dispersed fluid flow regime as described. The control valve may be responsive to measured changes in the concentration of dissolved oxygen. Alternatively the flow may be controlled to compensate for various changes in the tank such as feeding, temperature changes, or the like. The valve may be controlled by an automated control system or manually

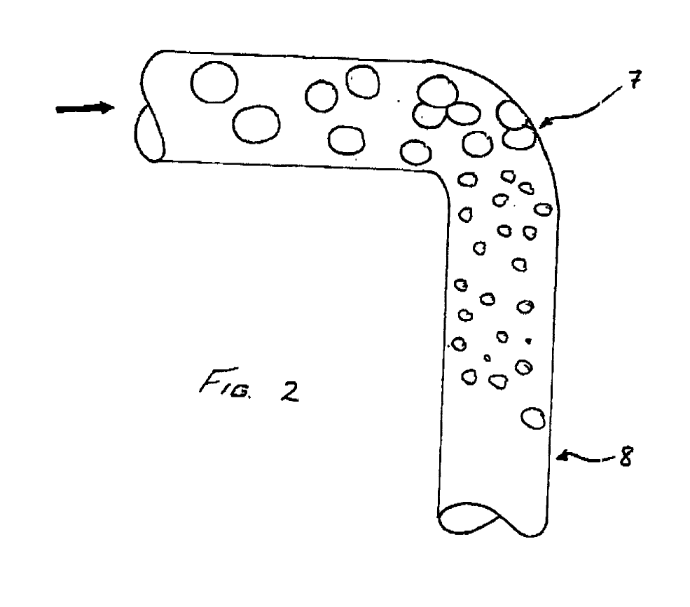

The two-phase flow then enters a dissolver 6. At each bend is a turbulent dissolver zone 7 where the oxygen bubble size is reduced and the two phases are violently mixed as shown in FIG. 2. The reduced bubble size significantly increases the surface area for mass transfer from the gas to the liquid phase. The two-phase flow exits the bend to a contact dissolver zone 8 in the form of a straight length of dissolver piping, which provides contact time for mass transfer. The process is repeated through alternating bends and straight lengths in the dissolver piping until a desired concentration of dissolved oxygen is achieved. The oxygenated stream produced consists of water saturated with oxygen at the elevated pressure and any remaining minute oxygen bubbles in a dispersed flow regime.

At the end of the dissolver piping, the pipe diameter is decreased to reduce the velocity of the oxygenated stream. The lower velocity ensures that the pressure of the stream does not drop rapidly and that the stream is not subjected to high turbulence in the downstream piping, thus maintaining the dissolution of the oxygen. However, the velocity is also maintained sufficiently high to minimise the coalesce of any gas hubbies present in the dispersed flow.

The pipe carrying the oxygenated stream is connected to a pipe network in the bulk water to be oxygenated. In tanks where the water has an inherent bulk movement, for example where the body of water is continuously being refreshed, then it is sufficient for the network to merely to inject the oxygenated stream as a single jet.

The applicant's have observed that when a jet of water is injected into the bulk with sufficient velocity it entrains the bulk water adjacent the jet. By way of this phenomenon, a jet of water with a high concentration of dissolved oxygen will be substantially diluted within a few jet diameters. This has particular advantages in aquaculture applications, as it is believed that fish can be harmed by exposure to high concentrations of oxygen. However, for tanks with no inherent bulk movement, the pipe network is required to perform a number of functions. As above, the oxygenated water should be injected through jets to promote rapid dilution of the oxygen into the bulk liquid by entrainment.

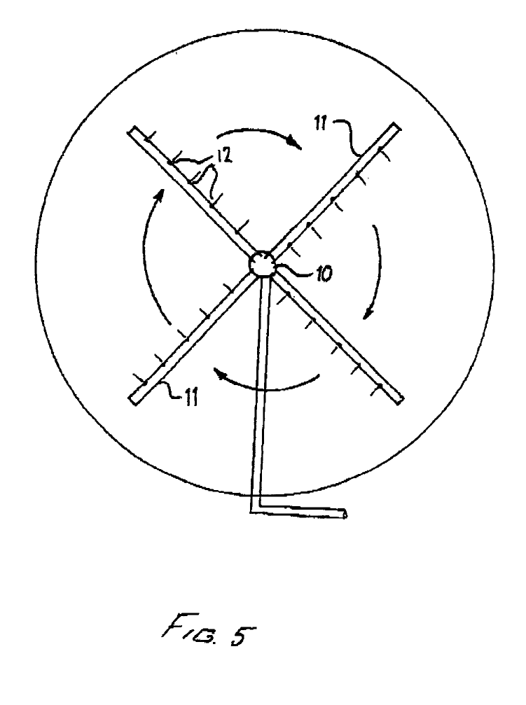

Also importantly, the network should provide an array of jets that, in combination, promote the movement of the bulk water to encourage consistent mixing. One example of a suitable array is shown in FIG. 5 where the oxygenated stream to a central hub 10 is fed. The stream is then directed from the hub through a number of pipes 11 each having a number of directed jets 12 at spaced positions on each. In the example shown, the jets all face in a clockwise direction. In this manner, a generally clockwise movement can be imparted to the bulk liquid. This has the added advantage that the water entrained by each jet will come from the region generally behind the jet. This water will have a generally lower oxygen concentration then that in front of the jets which also aids in avoiding regions with overly high oxygen concentrations.

Also as the jets 12 are, in practice, simply small holes (around 3-6 mm) they prevent large pressure drops in the oxygenated stream leaving the dissolver. In this manner, the amount of oxygen remaining in solution can be maximised.

Finally, the high jet velocities prevent the coalescence of any small oxygen bubbles in the oxygenated stream. Indeed, the turbulent nature of the jets and the associated entrainment ensure rapid dispersion of any bubbles as well as breaking up any larger bubbles.

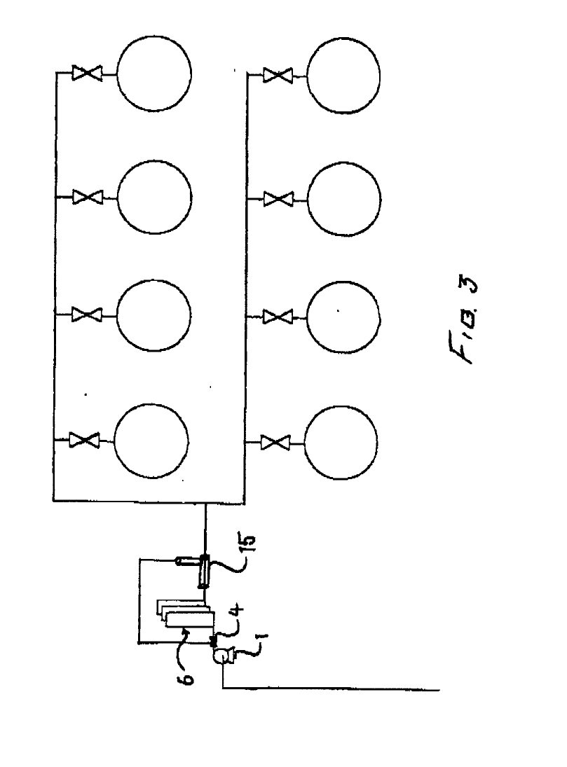

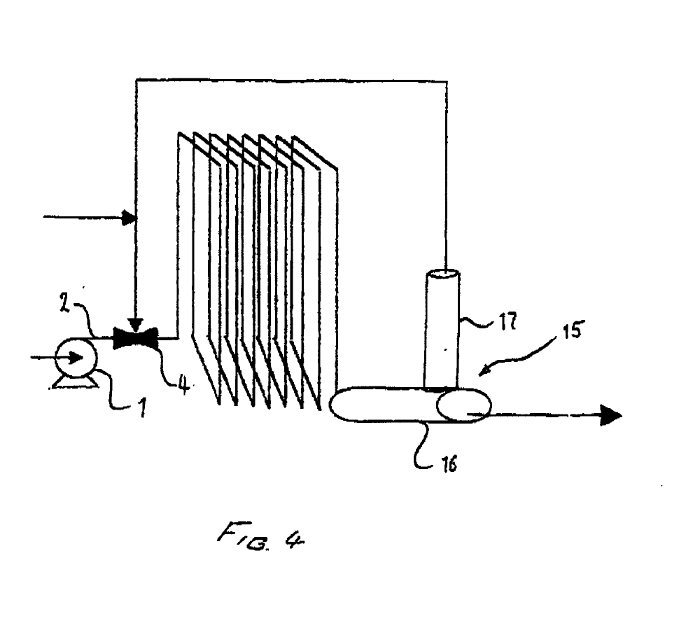

In other applications, where an aquaculture form has a number of tanks it is desirable to link them together with an oxygenation network. An example of such a network is shown in FIG. 3. Many features of the apparatus and method for these applications are similar to those for single tanks. However, such networks have longer piping so it is important to minimise the amount of undissolved oxygen in the oxygenated stream as any such bubbles are more likely to coalesce into a discrete gas phase.

For this reason, a phase separator 15 is provided downstream of the final dissolver loop. The phase separator consists of a horizontal vessel 16 and a vertical tower 17.

The diameter of the horizontal vessel is larger than the diameter of the dissolver piping, thus the velocity of the fluid is reduced. The length of the horizontal vessel is selected such that, in conjunction with the reduced velocity, a desired fluid residence time in the horizontal vessel can be achieved. This residence time should be sufficient to allow the undissolved gas bubbles rise to the top of the horizontal vessel. These bubbles are then collected in the vertical tower, The oxygenated stream then exits the horizontal vessel to the distribution pipe network.

The separated gas phase collected in the vertical tower is then recycled to the venturi 4 at the beginning of the dissolver 6 piping. The recycle gas flow rate capacity is fixed for any particular operating mode of the venturi. Thus, if less undissolved gas is collected, the liquid/gas interface level in the vertical tower will rise and if more undissolved gas is collected the liquid/gas interface level in the vertical tower will fall.

To maintain a consistent supply of oxygen to the pressurised stream, additional oxygen can augment the recycled oxygen. The flow of this additional oxygen is controlled by a valve responsive to changes in the level of the liquid gas interface in the vertical tower. More oxygen will be introduced on a high or rising liquid/gas interface and less oxygen on a falling or low liquid/gas interface.

The operating pressure of the phase separator 15 determines the concentration of dissolved oxygen in the liquid as increasing the stream pressure increases the quantity of oxygen that can be dissolved in water at saturation. The pressure in the phase separator is controlled by the pump speed; increasing the pump speed increases the phase separator pressure and decreasing the pump speed reduces the phase separator pressure.

Substantially single phase oxygenated stream exits the horizontal vessel into the distribution pipe network that distributes the oxygen to each body of bulk water. An optimal velocity is maintained by the pipe diameters of the distribution pipe network; the velocity is sufficiently low to ensure that the pressure of the liquid is not reduced rapidly in the downstream piping and the liquid is not exposed to high turbulence in the down stream piping, thus maintaining the dissolution of the oxygen; the velocity is maintained high enough to mitigate any coalescence of gas bubbles of sizes that are not collected in the phase separator.

The quantity of liquid entering each tank or body of water is controlled by the back pressure imposed on the liquid at each body of water. A control valve or a control valve in conjunction with a distribution network within the body of water to be oxygenated provides the backpressure.

As in the single tank example, the manner by which the oxygenated strearm is introduced into each tank will depend on whether the tanks have some inherent movement.

Also similarly to the single tank example, the control valve for each tank may be controlled automatically or manually in response to changing conditions in each tank.

Some factors that may effect oxygen demand include the size of the fish, the water temperature and other such as increased metabolism at feeding time.

Some of these factors, such as water temperature impact on each tank and accordingly if may be appropriate to increase the oxygen supply across the whole oxygenation network.

One way of effecting such a global change is by increasing the pressure in the phase separator. Doing so will increase the concentration of oxygen in the liquid and also increase the liquid flow to each body of water as the pressure driving force is increased. It will be appreciated that the quantity of oxygen to each body of water will increase by both effects. Thus, predictable effects including, but not limited to, diurnal changes, water temperature, feeding regimes and biomass increase which effect the demand of all the bulk water bodies are used to adjust the separator pressure, and as a result, optimise the oxygen utilisation.

If the number of bulk water consumers in the distribution network changes, the control of the pump speed by the separator pressure will adjust the operating point to maintain constant oxygenation to the bulk water bodies within the pump operating and performance parameters.

Although the invention has been described with reference to specific examples it will be appreciated to those skilled in the art that the invention may be embodied in many other forms.

We claim:

1. A method for dissolving oxygen in water, the method including the following steps:
generating a pressurised stream of water;
introducing a supply of a oxygen containing gas to said pressurised stream of water to produce a two phase flow;
passing the two phase flow through a turbulent dissolver zone whereby the gas bubble size is reduced and the two phases are violently mixed;
passing the two phase flow through a contact dissolver zone allowing time for mass transfer between the smaller bubbles and the water;
where required, repeating steps c) and d) until a desired level of dissolved gas is achieved at said elevated pressure.

2. A method according to claim 1 wherein the velocity of the pressurised stream is increased prior to the supply of the oxygen gas.

3. A method according to claim 1 wherein, the pressurised stream of water is generated within a conduit by a pump,

4. A method according to claim 1 wherein, the pressurised stream of water is generated by way of a gravity drop systems.

5. A method according to claim 1 wherein, the flow velocity of the pressurised stream is increased by narrowing the conduit from a first cross-section to a second smaller cross-section.

6. A method according to claim 1 wherein said contact dissolver zone comprises a length of piping.

7. A method according to claim 6 wherein, the length of piping is of substantially constant cross-section.

8. A method according to claim 1 wherein, the second, smaller cross-section to the conduit is substantially equal to that of the piping used to define the dissolver zones.

9. An apparatus for dissolving oxygen containing gas in water, the apparatus including:
means for generating a pressurised stream of water;
gas mixing means for mixing said pressurised stream with a supply of gas to form a two phase flow; and
a dissolver including;
at least one turbulent dissolver zone arranged to promote violent mixing of said two phase flow; and
at least one contact dissolver zone arranged to promote enhanced mass transfer in said two phase flow.

10. An apparatus according to claim 9 wherein means are provided to increase the flow velocity of the pressurised stream upstream of the gas mixing means.

11. An apparatus according to claim 9 wherein the apparatus also includes a phase separator to remove at least some of any gas bubbles remaining in the gasified stream.

12. An apparatus according to claim 11 wherein said phase separator includes a horizontal vessel and a vertical tower.

13. An apparatus according to claim 12 wherein said removed gas bubbles are collected in said vertical tower.

14. An apparatus according to claim 11 wherein the gasified stream exits said horizontal vessel into a distribution network.

15. An apparatus according to claim 9 wherein, the removed gas bubbles are recycled to the gas mixing means.

16. An apparatus according to claim 12 wherein the flow rate of said supply of gas is responsive to the quantity of removed gas recycled to the gas mixing means.

17. An apparatus for distributing an oxygenated stream of water into a bulk volume of water, the apparatus including means for increasing the velocity of said stream and means for injecting the stream into the bulk volume in a jet such that bulk water adjacent said oxygenated stream is entrained with the jet thereby to promote mixing therebetween.

18. An apparatus according to claim 14 wherein, said means for injecting is oriented duce movement of the bulk volume.
